(19) United States
(12) Patent Application Publication
(10) Pub. No.: US 2005/0083282 A1
(43) Pub. Date: Apr. 21, 2005

(54) Liquid crystal display device and driving method to be used in same

(75) Inventor: Nobuaki Honbo, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC LCD Technologies, Ltd., Kawasaki-shi (JP)

(21) Appl. No.: 10/965,806

(22) Filed: Oct. 18, 2004

(30) Foreign Application Priority Data
Oct. 17, 2003 (JP) 2003-358591

(51) Int. Cl. G09G 3/36

(52) U.S. Cl. 345/87

(57) ABSTRACT

A liquid crystal display device is provided in which its cold cathode fluorescent tube serving as a surface light source block can reliably light up and efficiency of feeding light to a liquid crystal panel can be enhanced. When timing signals are fed to frequency setting sections, a frequency of each of driving pulse voltages becomes as high as a frequency being near to a resonant frequency corresponding to a floating capacitance occurring at start time of lighting of backlights and then becomes as low as a frequency being near to a resonant frequency corresponding to floating capacitance occurring at a stabilized period of lighting of the backlights. Therefore, the backlight, even if lighting duration of its cold cathode fluorescent tube is long, lights up reliably and a power factor is improved to improve efficiency of feeding light to the liquid crystal panel.

### BACKGROUND OF THE INVENTION

1. Field of the Invention

The present invention relates to a liquid crystal display device and a driving method to be used in the liquid crystal display device and more particularly to the liquid crystal display device having a surface light source, such as a cold cathode fluorescent tube, which lights up when a driving pulse voltage is applied to from an inverter and the driving method to be used in the above liquid crystal display device.

The present application claims priority of Japanese Patent Application No. 2003-358591 filed on Oct. 17, 2003, which is hereby incorporated by reference.

2. Description of the Related Art

In recent years, among image display devices, a liquid crystal display device, in particular, is made larger in size and high-definition and is used not only in a device to display freeze-frame images in such a personal computer and/or word processor but also in a device to display moving images such as a television (TV). It is expected that the liquid crystal display device, since its physical depth is less and its occupied area is smaller compared with a television equipped with a CRT (Cathode Ray Tube), has a higher marketing potential for home use in the future.

In many cases, the liquid crystal display device uses a cold cathode fluorescent tube as one of components making up a surface light source (for example, backlight) to illuminate a liquid crystal panel. The cold cathode fluorescent tube has a resonant circuit made up of a transformer in an inverter, auxiliary capacitor for resonance, and floating capacitance. When a driving pulse voltage set so as to have a resonant frequency being almost equal to a frequency of the resonant circuit is applied from the inverter, the cold cathode fluorescent tube lights up.

As shown in FIG. 14, the liquid crystal display device of the type described above includes a liquid crystal panel 1, a data electrode driving circuit 2, a scanning electrode driving circuit 3, a controlling section 4, a lighting timing controlling section 5, an inverter 6, and a backlight 7. The liquid crystal panel 1 has data electrodes Xᵢ (i=1, 2, . . . , m; for example, m=640×3), scanning electrodes Yⱼ (j=1, 2, . . . , n; for example, n=512), and pixel cells 10ᵢ, ⱼ. The data electrodes Xᵢ are arranged at specified intervals in an “x” direction, to which a voltage corresponding to pixel data Dᵢ is applied. The scanning electrodes Yⱼ are arranged at specified intervals in a “y” direction (that is, scanning direction) orthogonal to the “x” direction to which a scanning signal OUTⱼ to write the pixel data Dᵢ is sequentially applied. Each of the pixel cells 10_{i,j} is formed in a one-to-one relationship with a region of intersections of each of the data electrodes Xᵢ and each of the scanning electrodes Yⱼ and is made up of a TFT (Thin Film Transistor) 11ᵢ,ⱼ, a liquid crystal cell 12_{i,j}, if and a commnon electrode COM. The TFT 11ᵢ,ⱼ is controlled ON/OFF according to a scanning signal OUTⱼ and, when it is put into an ON state, applies a voltage corresponding to the pixel data Dᵢ to the liquid crystal cell 12ᵢ,ⱼ. In the liquid crystal panel 1, when a scanning signal OUTⱼ is sequentially applied to the scanning electrode Yⱼ and when a corresponding pixel data Dᵢ is applied to the data electrode Xᵢ, the corresponding pixel data Dᵢ is fed to each liquid crystal cell 12_{i,j} and a modulation is performed on light emitted from the backlight 7 in a manner to respond to an image to be displayed.

The data electrode driving circuit 2 applies a voltage corresponding to pixel data D₁ to each of the data electrodes Xᵢ according to a video input signal VD. The scanning electrode driving circuit 3 applies a scanning signal OUTⱼ to the scanning electrodes Yⱼ in a one-pass scanning manner. The controlling section 4 transmits a control signal “a” to the data electrode driving circuit 2 and a control signal “b” to the scanning electrode driving circuit 3. The controlling section 4 also transmits a vertical sync signal “c” to the lighting timing controlling section 5 according to the video input signal VD. The light timing controlling section 5 generates a timing signal “d” to make the backlight 7 flash on and off according to the vertical sync signal “c” in every frame period for the video input signal VD in a manner to correspond to a response characteristic of each of the liquid crystal cells 12_{i,j} in the liquid crystal panel 1.

The inverter 6 has a resonant circuit which resonates in combination with floating capacitance mounted in the backlight 7, produces, by using commercial power, a driving pulse voltage “e” having almost the same resonant frequency as that of the resonant circuit in synchronization with the timing signal “d” and applies it to the backlight 7. A frequency and a pulse width of the driving pulse voltage “e” is set according to a set frequency “f” and a voltage of the driving pulse voltage “e” is set according to a set voltage “v”. The backlight 7 is mounted on a rear of the liquid crystal panel 1 and lights up when the driving pulse voltage “e” is applied to from the inverter 6 and uniformly illuminates the liquid crystal panel 1.

FIG. 15 is a diagram illustrating inner configurations of the backlight 7 mounted in the conventional liquid crystal display shown in FIG. 14. The backlight 7, as shown in FIG. 15, is made up of cold cathode fluorescent tubes 21 and 22, a reflecting sheet 23, a lighting curtain 24, and a diffusing sheet 25. The reflecting sheet 23 is constructed by using a sputtering method to overlay silver on a film such as PET (polyethylene terephthalate) which serves to improve efficiency of feeding light to the liquid crystal panel 1. In the backlight 7 configured as above, an amount of light emitted from the cold cathode fluorescent tubes 21 and 22 and reflected from the reflecting sheet 23 is decreased by the lighting curtain 24 or diffused by the diffusing sheet 25 and, as a result, its luminance is made uniform. Therefore, the backlight 7 plays a role as a surface light source.

FIG. 16 is a diagram illustrating another example of inner configurations of the backlight 7 mounted in the conventional liquid crystal display shown in FIG. 14. The backlight 7, as shown in FIG. 16, is made up of a cold cathode fluorescent tube 31, a reflecting mirror 32, a reflecting sheet 33, a light-guiding plate 34, and a diffusing sheet 35. The reflecting mirror 32 and the reflecting sheet 33 are constructed by using a sputtering method to overlay silver on a film such as PET which serves to enhance efficiency of feeding light into the liquid crystal panel 1. In the backlight 7 configured as above, light emitted from the cold cathode tube 31 and reflected from the reflecting mirror 32 travels in a manner to be reflected totally through the light-guiding plate 34 and diffused by the diffusing sheet 35, which serves to unify luminance of the liquid crystal panel 1 and, as a result, the backlight 7 plays a role as a surface light source.

FIG. 17 is a schematic diagram illustrating the inverter 6 shown in FIG. 14, the cold cathode fluorescent tube 31, and the reflecting mirror 32 shown in FIG. 16. The inverter 6, as shown in FIG. 17, is made up of a high-frequency wave generating section 6a and a transformer 6b. On a secondary coil side of the transformer 6b, a floating capacitance 6c occurs and on a side of output of the inverter 6 is connected an auxiliary capacitor 6d for resonance. Another floating capacitor (not shown) is connected in a wiring between the backlight 7 and inverter 6. The other floating capacitor, the transformer 6b, the floating capacitor 6c, and auxiliary capacitor for resonance 6d make up a resonant circuit. In the inverter 6 shown in FIG. 17, a high-frequency voltage corresponding to the set frequency “f” and the set voltage “v” is produced, by using commercial power, in the high-frequency wave generating section 6a in synchronization with the timing signal “d” and is output as the driving pulse voltage “e” through the transformer 6b. The driving pulse voltage “e” is applied to the backlight 7.

FIG. 18 is a diagram showing electrical configurations of another conventional liquid crystal display device. The liquid crystal device shown in FIG. 18 has a voltage setting section 8 in addition to components employed in the liquid crystal display device shown in FIG. 14. The voltage setting section 8 feeds a set voltage “vM” to the inverter 6 in synchronization with the timing signal “d” so that the driving pulse voltage “e” is gradually increased from an initial value to a set voltage during a period from start time of lighting of the backlight 7 to specified time. In the liquid crystal display device shown in FIG. 19, the driving pulse voltage “e”, after having gradually increased from its initial value to its set value during a period from time “t1” being time of start of lighting of the backlight 7 to time “t2”, becomes constant from the time “t2” to “t3” and, thereafter, same operations are repeated. In the case where the driving pulse voltage “e” does not gradually increase during the period from time “t1” to time “t2” and is a set voltage from the beginning, there are some cases in which each of components in the inverter 6 and backlight 7 mechanically vibrate, causing a vibration sound (noise) to come out, however, according to the above liquid crystal display device, the vibration sound is suppressed by the set voltage “vM” preset by the voltage setting section 8.

Moreover, up to now, no proper information about references of the prior art is available.

However, such the conventional liquid crystal display devices as described above has following problems. For example, in the backlight 7 employed in the conventional liquid crystal display device shown in FIG. 16, the reflecting mirror 32, since it is constructed by using a sputtering method to overlay silver on a film, is conductive. Therefore, as shown in FIG. 20, when conductive plasma P is generated internally by lighting of the cold cathode fluorescent tube 31, electrostatic capacitance S and S is produced between the reflecting mirror 32 and the plasma P and, as a result, floating capacitance in the backlight 7 increases. Due to this, a resonant frequency becomes low during a stabilized period of lighting of the cold cathode fluorescent tube 31 rather than during its initial and the longer the cold cathode fluorescent tube 31 becomes, the larger the electrostatic capacitance S and S becomes and the greater the variation becomes.

Therefore, when a frequency of a driving pulse voltage “e” is set to be a resonant frequency occurring in an initial period of lighting of the backlight 7, since a big difference between the frequency of the driving pulse voltage “e” and the resonant frequency occurring in the initial period of lighting of the backlight 7 occurs, a power factor decreases which worsens efficiency of feeding light to the liquid crystal panel. Also, when a frequency of a driving pulse voltage “e” is set to be a resonant frequency occurring in a stabilized period of lighting of the backlight 7, since a big difference between the frequency of the driving pulse voltage “e” and the resonant frequency occurring in the initial period of lighting of the backlight 7 occurs, there is a problem that no resonance occurs and the backlight 7 does not light up to illuminate the liquid crystal panel. Almost the same problems as this occur in the backlight 7 shown in FIG. 15. Also, in the liquid crystal display device shown in FIG. 18, since the driving pulse voltage “e” being applied during a period from the time t1 to the time t2 is lower than a set value, if there is a big difference between a frequency of the driving pulse voltage “e” and a resonant frequency occurring in the initial period of lighting of the backlight 7, the problem that the backlight 7 does not light up smoothly becomes serious. Furthermore, the liquid crystal display device shown in FIG. 18 has also a problem in that, when the backlight 7 is powered off or powered down at the time “t3” shown in FIG. 19, each of components making up the inverter 6 and each of components making up the backlight 7 mechanically vibrate which causes a vibration sound to occur.

### SUMMARY OF THE INVENTION

In view of the above, it is an object of the present invention to provide a liquid crystal display device being capable of making its cold cathode fluorescent tube serving as a surface light source light up reliably and of enhancing efficiency of feeding light to the liquid crystal panel.

According to a first aspect of the present invention, there is provided a liquid crystal display device including:
a liquid crystal panel;
at least one surface light source to uniformly illuminate the liquid crystal panel; and
at least one surface light source driving section to apply a driving pulse voltage to the surface light source; and
wherein, at least one frequency setting section is added, which changes, when a transition occurs from an initial state of lighting of the surface light source to its stabilized state, a set value of a frequency of the driving pulse voltage.

In the foregoing first aspect, a preferable mode is one wherein the surface light source driving section includes: a resonant circuit configured so as to resonate in combination with a floating capacitance occurring in the surface light source and to apply the driving pulse voltage whose frequency is set to be a frequency being near to a resonant frequency of the resonant circuit to the surface light source; and wherein the frequency setting section is so configured as to change a set value of a frequency of the driving pulse voltage according to a decrease in the resonant frequency caused by an increase in the floating capacitance occurring when the transition occurs from the initial state of lighting of the surface light source to the stabilized state.

Another preferable mode is one wherein the surface light source includes:
a cold cathode fluorescent tube which lights up when the driving pulse voltage is applied to;
a reflecting section which reflects light emitted from the cold cathode fluorescent tube and which increases the floating capacitance tore in the stabilized period of lighting of the cold cathode fluorescent tube rather than in the initial state by making an electrostatic capacitance be produced between the reflecting section and a plasma generated within the cold cathode fluorescent tube;
a diffusing section which diffuses light reflected from the reflecting section and light emitted from the cold cathode fluorescent tube to illuminate the liquid crystal panel uniformly; and
wherein the frequency setting section is so configured as to set a frequency of the driving pulse voltage to be a frequency being near to a resonant frequency corresponding to the floating capacitance occurring in the initial period of lighting of the cold cathode fluorescent tube and then to set the frequency to be a frequency being near to the resonant frequency corresponding to the floating capacitance occurring in the stabilized period of lighting of the cold cathode fluorescent tube.

Still another preferable mode is one wherein the frequency setting section is so configured as to gradually increase, when a transition occurs from the initial state of lighting of the surface light source to its stabilized state, each the driving pulse voltage from an initial value to a value corresponding to a specified amount of light emitted from the surface light source. An additional preferable mode is one wherein the frequency setting section is so configured as to gradually decrease, when a transition occurs from the stabilized state of lighting of the surface light source to a state of power-off or power-down of lighting of the surface light source, each the driving pulse voltage from a value corresponding to a specified amount of light emitted from the surface light source to its initial value.

According to a second aspect of the present invention, there is provided a liquid crystal display device including:
a liquid crystal panel;
a surface light source to uniformly illuminate the liquid crystal panel;
a surface light source driving section to apply a driving pulse voltage to the surface light source;
a voltage setting section which sets the driving pulse voltage so as to gradually increase during a period from a start time of lighting of the surface light source to a specified time; and
wherein a frequency setting section is added which changes a set value of a frequency of the driving pulse voltage after a lapse of the period from the start time of lighting of the surface light source to the specified time.

In the foregoing second aspect, a preferable mode is one wherein the surface light source driving section includes: a resonant circuit that resonates in combination with a floating capacitance occurring in the surface light source and is so configured as to apply the driving pulse voltage whose frequency is set to be a frequency being near to a resonant frequency of the resonant circuit to the surface light source; and wherein the frequency setting section is so configured as to change a set value of a frequency of the driving pulse voltage according to a decrease in the resonant frequency caused by an increase in the floating capacitance occurring after the lapse of the period from the start time of lighting of the surface light source to the specified time.

Another preferable mode is one wherein the surface light source includes:
a cold cathode fluorescent tube which lights up when the driving pulse voltage is applied;
a reflecting section which reflects light emitted from the cold cathode fluorescent tube and increases the floating capacitance more after the lapse of the specified period rather than at the start time of lighting of the cold cathode fluorescent tube by making an electrostatic capacitor be produced between the reflecting section and a plasma generated within the cold cathode fluorescent tube;
a diffusing section which diffuses light reflected from the reflecting section and light emitted from the cold cathode fluorescent tube to illuminate the liquid crystal panel uniformly; and
wherein the frequency setting section is so configured as to set a frequency of the driving pulse voltage to be a frequency being near to a resonant frequency corresponding to the floating capacitance occurring at the time of lighting of the cold cathode fluorescent tube and, after the lapse of the specified period, to be a frequency being near to a resonant frequency corresponding to the floating capacitance occurring in the stabilized period of lighting of the cold cathode fluorescent tube.

According to a third aspect of the present invention, there is provided a liquid crystal display device including:
a liquid crystal panel;
two or more surface light source blocks which are divided in a scanning direction of the liquid crystal panel and light up when a driving pulse voltage is applied to and are used to uniformly illuminate related regions in the liquid crystal panel;
a lighting timing controlling section which divides one frame period for a video input signal into two or more frame blocks each corresponding to a length in the scanning direction of each of the surface light source blocks and which generates two or more timing signals to make each of the surface light source blocks flash on and off in a manner to correspond to a response characteristic of the liquid crystal panel during each of the frame blocks; and
two or more surface light source block driving sections to apply each driving pulse voltage to each of the surface light source blocks in synchronization with each of the timing signals;
wherein two or more frequency setting sections are added to change a set value of a frequency of each the driving pulse voltages, when a transition occurs from an initial state of lighting of each of the surface light source blocks to its stabilized state.

In the foregoing third aspect, a preferable mode is one wherein each of the surface light blocks has a resonant circuit which resonates in combination with a floating capacitance occurring in each of the surface light source blocks and wherein each of the surface light source blocks applies each the driving pulse voltages whose frequency is set to be a frequency being near to a resonant frequency of the resonant circuit to each of the surface light source blocks in synchronization with each of the timing signals; and wherein each of the frequency setting sections is so configured as to change a set value of a frequency of each the driving pulse voltages according to a decrease in the resonant frequency caused by an increase in the floating capacitance occurring when a transition occurs from the initial state of lighting of each of the surface light source blocks to the stabilized state.

Another preferable mode is one wherein each of the surface light source blocks includes:
a cold cathode fluorescent tube which lights up when each of the driving pulse voltages is applied to;
a reflecting section which reflects light emitted from the cold cathode fluorescent tube and which increases the floating capacitance more in a stabilized period of lighting of the cold cathode fluorescent tube rather than in the initial state by making an electrostatic, capacitor be produced between the reflecting section and plasma generated within the cold cathode fluorescent tube;
a diffusing section which diffuses light reflected from the reflecting section and light emitted from the cold cathode fluorescent tube to illuminate the liquid crystal panel uniformly,
wherein the frequency setting section is so configured as to set a frequency of the driving pulse voltages to be a frequency being near to a resonant frequency corresponding to the floating capacitance occurring in an initial period of lighting of the cold cathode fluorescent tube and then the frequency to be a frequency being near to a resonant frequency corresponding to the floating capacitance occurring in the stabilized period of lighting of the cold cathode fluorescent tube.

Still another preferable mode is one wherein each of the frequency setting sections is so configured as to gradually increase, when a transition occurs from the initial state of lighting of each of the surface light source blocks to the stabilized state, each the driving pulse voltage from the initial value to a value corresponding to a specified amount of light emitted from each of the surface light source blocks.

An additional preferable mode is one wherein each of the frequency setting sections is so configured as to gradually decrease, when a transition occurs from the stabilized state of lighting of each of the surface light source blocks to a state of power-off or power-down of each of the surface light source blocks, each the driving pulse voltage from a value corresponding to a specified amount of light emitted from each of the surface light source blocks to the initial value.

According to a fourth aspect of the present invention, there is provided a liquid crystal display device including:
a liquid crystal panel;
two or more surface light source blocks which are divided in a scanning direction of the liquid crystal panel and light up when a driving pulse voltage is applied to and uniformly illuminate related regions in the liquid crystal panel;
a lighting timing controlling section which divides one frame period for a video input signal into two or more frame blocks each corresponding to a length in the scanning direction of each of the surface light source blocks and which generates two or more timing signals to make each of the surface light source blocks flash on and off in a manner to correspond to a response characteristic of the liquid crystal panel during each of the frame blocks;
two or more surface light source block driving sections to apply each driving pulse voltage to the surface light source blocks in synchronization with the timing signals; and
two or more voltage setting sections to set the driving pulse voltage so as to gradually increase from an initial value to a set value during a period from a start time of lighting of each of the surface light source blocks to a specified time; and
wherein two or more frequency setting sections are added which change a frequency of each driving pulse voltage after a lapse of the period from the start time of lighting of each of the surface light source blocks to the specified time.

In the foregoing fourth aspect, a preferable mode is one wherein each of the surface light source block driving sections includes a resonant circuit which resonates in combination with a floating capacitance occurring in the surface light source block and is so configured as to apply each the driving pulse voltage whose frequency is set to be near to a resonant frequency of the resonant circuit to the surface light source block in synchronization with each of the timing pulses, and wherein each of the frequency setting sections changes a set value of a frequency of each the driving pulse voltage according to a decrease in the resonant frequency caused by an increase in the floating capacitance occurring after a lapse of the period from the start time of lighting of each of the surface light source blocks to the specified time.

Another preferable mode is one wherein each of the surface light source blocks includes:
a cold cathode fluorescent tube which lights up when each of the driving pulse voltages is applied to;
a reflecting section which reflects light emitted from the cold cathode fluorescent tube and which increases the floating capacitance more in a stabilized period of lighting of the cold cathode fluorescent tube rather than in its initial period by making an electrostatic capacitance be produced between the reflecting section and a plasma generated within the cold cathode fluorescent tube;
a diffusing section which diffuses light reflected from the reflecting section and light emitted from the cold cathode fluorescent tube to illuminate the liquid crystal panel uniformly,
wherein the frequency setting section is so configured as to set a frequency of the driving pulse voltages to be a frequency being near to a resonant frequency corresponding to the floating capacitance occurring at the start time of lighting of the cold cathode fluorescent tube and, after a lapse of the specified period, the frequency to be a frequency being near to a resonant frequency corresponding to the floating capacitance occurring in a stabilized period of lighting of the cold cathode fluorescent tube.

According to a fifth aspect of the present intention, there is provided a driving method to be used in a liquid crystal display device having a liquid crystal panel, at least one surface light source to uniformly illuminate the liquid crystal panel, and at least one surface light source driving section to apply a driving pulse voltage to the surface light source, for driving the surface light source, the method including:
a frequency setting step of changing, when a transition occurs from an initial state of lighting of the surface light source to its stabilized state, a set value of a frequency of the driving pulse voltage.

In the foregoing fifth aspect, a preferable mode is one wherein, in the frequency setting step, when a transition occurs from the initial state of lighting of the surface light source to the stabilized states the driving pulse voltage is gradually increased from the initial value to a value corresponding to the specified amount of light emitted from the surface light source.

Another preferable mode is one wherein, in the frequency setting step, when a transition occurs from the stabilized state of lighting of the surface light source to a power-off or power-down state, the driving pulse voltage is gradually decreased from a value corresponding to the specified amount of light emitted from the surface light source to the initial value.

According to a sixth aspect of the present invention, there is provided a driving method to be used in a liquid crystal display device having a liquid crystal panel, a surface light source to uniformly illuminate the liquid crystal panel, a surface light source driving section to apply a driving pulse voltage to the surface light source, and a voltage setting section which sets the driving pulse voltage so as to gradually increase during a period from a start time of lighting of the surface light source to a specified time, for driving the surface light source, the method including:
a frequency setting step of changing a set value of a frequency of the driving pulse voltage after a lapse of the period from the start time of lighting of the surface light source to the specified time.

According to a seventh aspect of the present invention, there is provided a driving method to be used in a liquid crystal display device having a liquid crystal panel, two or more surface light source blocks which are divided in a scanning direction of the liquid crystal panel and light up when a driving pulse voltage is applied to and are used to uniformly illuminate related regions in the liquid crystal panel, a lighting timing controlling section which divides one frame period for a video input signal into two or more frame blocks each corresponding to a length in the scanning direction of each of the surface light source blocks and which generates two or more timing signals to make each of the surface light source blocks flash on and off in a manner to correspond to a response characteristic of the liquid crystal panel during every frame block, and two or more surface light source block driving sections to apply each driving pulse voltage to each of the surface light source blocks in synchronization with each of the timing signals, for driving the surface light source blocks, the method including:
a frequency setting step of changing a set value of a frequency of each the driving pulse voltage, when a transition occurs from an initial state of lighting of each of the surface light source blocks to its stabilized state.

The the foregoing seventh aspect, a preferable mode is one wherein, in the frequency setting step, when a transition occurs from an initial state of lighting of each of the surface light source blocks to the stabilized state, the driving pulse voltage is gradually increased from an initial value to a value corresponding to the specified amount of light emitted from each of the surface light source blocks.

Another preferable mode is one wherein, in the frequency setting step, when a transition occurs from the stabilized state of lighting of each of the surface light source blocks to a power-off or power-down state, the driving pulse voltage is gradually decreased from a value corresponding to the specified amount of light emitted from each of the surface light source blocks to the initial value.

According to an eighth aspect of the present invention, there is provided a driving method to be used in a liquid crystal display device having a liquid crystal panel, two or more surface light source blocks which are divided in a scanning direction of the liquid crystal panel and light up when a driving pulse voltage is applied to and uniformly illuminate related regions in the liquid crystal panel, a lighting timing controlling section which divides one frame period for a video input signal into two or more frame blocks each corresponding to a length in the scanning direction of each of the surface light source blocks and which generates two or more timing signals to make each of the surface light source blocks flash on and off in a manner to correspond to a response characteristic of the liquid crystal panel during each of the frame blocks, two or more surface light source block driving sections to apply each the driving pulse voltages to the surface light source blocks in synchronization with the timing signals, and two or more voltage setting sections to set the driving pulse voltages so as to gradually increase from an initial value to a set value during the period from start time of lighting of each of the surface light source blocks to the specified time, for driving the surface light source blocks, the method including;
a frequency setting step of changing a set value of a frequency of each driving pulse voltage after a lapse of the period from start time of lighting of each of the surface light source blocks to specified time.

With the above configuration, when the transition occurs from the initial state of lighting of the surface light source or the surface light source block to its stabilized state, a set value of a frequency of a driving pulse voltage is changed by the frequency setting section and, therefore, the surface light source or the surface light source block lights up reliably and efficiency of feeding light to the liquid crystal panel can be improved.

With another configuration as above, when a timing signal is input to the frequency setting section, a frequency of a driving pulse voltage is made as high as a frequency being near to a resonant frequency occurring in an initial period of lighting of the surface light source or the surface light source block and then is made as low as a frequency being near to a resonant frequency occurring after a start of lighting of the surface light source or surface light source block and, therefore, the surface light source or the surface light source block reliably lights up even if its lighting duration is long, and efficiency of feeding light to the liquid crystal panel can be improved.

With still another configuration as above, when a driving pulse voltage is set by the voltage setting section so as to gradually increase from its initial voltage to a set voltage during a period from a start time of lighting of the surface light source or the surface light source block to specified time, a frequency of a driving pulse voltage is set by the frequency setting section so as to be changeable according to a decrease in a resonant frequency occurring after a lapse of the period from start time of lighting of the surface light source or the surface light source block to specified time and, therefore, the surface light source or surface light source block can light up smoothly to illuminate the liquid crystal panel.

With still another configuration as above, when a transition occurs from the initial state of lighting of the surface light source or the surface light source block to its stabilized state, a driving pulse voltage gradually increases from its initial value to a value corresponding to a specified amount of light from the surface light source or the surface light source block and, therefore, the voltage setting section is not required and, as a result, the surface light source or the surface light source block can have a relatively simple configuration and can light up smoothly.

With still another configuration as above, a driving pulse voltage is set so as to be gradually decreased when the surface light source or the surface light source block is powered off or powered down and, therefore, occurrence of a vibration sound (noise) that occurs when the surface light source or the surface light source block is powered off or powered down can be prevented.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing electrical configurations of a liquid crystal display device according to a first embodiment of the present invention;

FIG. 2 is a diagram illustrating schematic configurations of a liquid crystal panel and backlights according to the first embodiment of the present invention;

FIG. 3 is a diagram illustrating configurations of the backlights according to the first embodiment of the present invention;

FIG. 4 is a timing chart explaining operations of the liquid crystal display device shown in FIG. 1;

FIG. 5 is an expanded diagram of a wave, in a time axis direction, occurring at time of rising of each of driving pulse voltages employed in the first embodiment of the present invention;

FIG. 6 is a schematic block diagram showing electrical configurations of a liquid crystal display device according to a second embodiment of the present invention;

FIG. 7 is a diagram showing a waveform of a pulse being input to a transformer of an inverter when a driving pulse voltage shown in FIG. 6 is boosted according to the second embodiment of the present invention;

FIG. 8 is a timing chart explaining operations of the liquid crystal display device according to the second embodiment of the present invention;

FIG. 9 is a schematic block diagram showing electrical configurations of a liquid crystal display device according to a third embodiment of the present invention;

FIG. 10 is a schematic block diagram showing electrical configurations of a liquid crystal display device according to a fourth embodiment of the present invention;

FIG. 11 is a diagram showing a waveform of a voltage to be applied to a transformer of an inverter which occurs at time of rising of a driving pulse voltage shown in FIG. 10;

FIG. 12 is a schematic block diagram showing electrical configurations of a liquid crystal display device according to a fifth embodiment of the present invention;

FIG. 13 is a timing chart explaining operations to be performed by the liquid crystal display device shown in FIG. 12;

FIG. 14 is a schematic block diagram showing electrical configurations of a conventional liquid crystal display;

FIG. 15 is a diagram illustrating inner configurations of a backlight mounted in the conventional liquid crystal display shown in FIG. 14;

FIG. 16 is a diagram illustrating another example of inner configurations of the backlight mounted in the conventional liquid crystal display shown in FIG. 14;

FIG. 17 is a schematic diagram illustrating an inverter shown in FIG. 14 and a cold cathode fluorescent tube and a reflecting mirror shown in FIG. 16;

FIG. 18 is a diagram showing electrical configurations of another conventional liquid crystal display device;

FIG. 19 is a timing chart explaining operations to be performed by the conventional liquid crystal display device shown in FIG. 18; and

FIG. 20 is a diagram explaining problems occurring in the conventional liquid crystal display device.

### DETAILED DESCRIPTION OF THE PREFERRED EMBODIMENTS

Best modes of carrying out the present invention will be described in further detail using various embodiments with reference to the accompanying drawings.

When a transition occurs from an initial state of lighting of a surface light source or a surface light source block (such as a cold cathode fluorescent tube) to its stabilized state, a frequency of a driving pulse voltage is set so as to be changeable according to a decrease in a resonant frequency caused by an increase in floating capacitance.

### First Embodiment

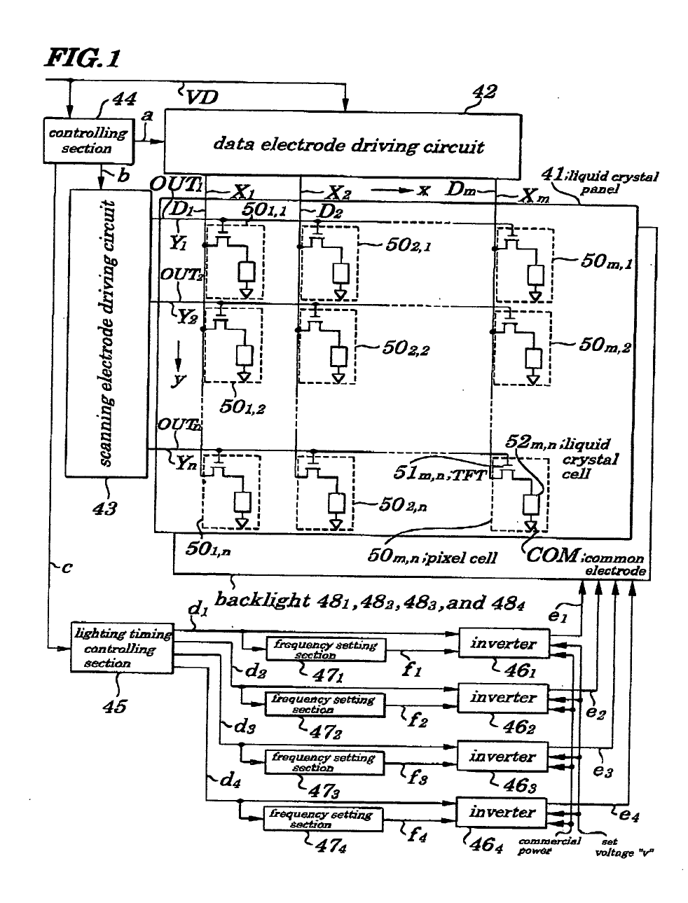

FIG. 1 is a schematic block diagram showing electrical configurations of a liquid crystal display device of a first embodiment of the present invention. The liquid crystal display of the first embodiment, as shown in FIG. 1, includes a liquid crystal panel 41, a data electrode driving circuit 42, a scanning electrode driving circuit 43, a controlling section 44, a lighting timing controlling section 45, inverters 46₁, 46₂, 46₃, and 46₄, and frequency setting sections 47₁, 47₂, 47₃, and 47₄, and backlights 48₁, 48₂, 48₃, and 48₄. The liquid crystal panel 41 is made up of data electrodes Xᵢ (i=1, 2, . . . , m; for example, m=640×3), scanning electrodes Yⱼ (j=1, 2, . . . , n; for example, n=512), and pixel cells 50ᵢ, _{,j} (i=1, 2, . . . , m; j=1, 2, . . . , n). The data electrodes Xᵢ are arranged at specified intervals in an “x” direction, to which a voltage corresponding to pixel data Dᵢ (i=1, 2, . . . , m) is applied. The scanning electrodes Yⱼ are arranged at specified intervals in a “y” direction (that is, scanning direction) orthogonal to the “x” direction to which a scanning signal OUTⱼ (j=1, 2, . . . , n) used to write the pixel data Dᵢ is sequentially applied Each of the pixel cells 50_{i,j} is formed in a one-to-one relationship with a region of intersections of each of the data electrodes Xᵢ and each of the scanning electrodes Yⱼ and is made up of a TFT 51ᵢ,ⱼ, (i=1, 2, . . . , m; j=1, 2, . . . , n) a liquid crystal cell 52_{i,j}, (i=1, 2, . . . m; j=1, 2, . . . , n). and a common electrode COM. The TFT 51ᵢ,ⱼ is controlled ON/OFF according to a scanning signal OUTⱼ and, when it is put into an ON state, applies a voltage corresponding to the pixel data Dᵢ to the liquid crystal cell 52_{i,j}. In the liquid crystal panel 41, when a scanning signal OUTⱼ is sequentially applied to the scanning electrode Yⱼ and when a corresponding pixel data Dᵢ is fed to the data electrode Xᵢ, the corresponding pixel data Dᵢ is fed to each liquid crystal cell 52_{i,j} and a modulation is performed on illuminating light emitted from the backlights 48₁, 48₂, 48₃, and 48₄ in a manner to respond to an image to be displayed.

The data electrode driving circuit 42 applies a voltage corresponding to pixel data D₁ to each data electrode X according to a video input signal VD. The scanning electrode driving circuit 43 applies a scanning signal OUTⱼ to each of the scanning electrodes Yⱼ in a one-pass scanning manner. The controlling section 44 transmits a control signal “a” to the data electrode driving circuit 42 and a control signal “b” to the scanning electrode driving circuit 43. The controlling section 44 also transmits a vertical sync signal “c” to the lighting timing controlling section 45 according to the video input signal VD. The light timing controlling section 45 divides, according to the vertical sync signal “c”, one frame period for the video input signal VD into two or more frame blocks [1], [2], [3], and [4] (as shown in FIG. 3) corresponding to a length of each of the backlights 48₁, 48₂, 48₃, and 48₄ in a scanning direction and generates timing signals “d1”, “d2”, “d3”, and “d4” to make each of the backlights 48₁, 48₂, 48₃, and 48₄ flash on and off in a manner to correspond to each liquid crystal cell 52ᵢ,ⱼ in the liquid crystal panel 41 during each of the frame blocks [1], [2], [3], and [4] (as shown in FIG. 3).

The inverters 46₁, 46₂, 46₃, and 46₄ are constructed by using the same configurations as a conventional inverter 6 shown in FIG. 13 and include a resonant circuit which resonates in combination with floating capacitance occurring in the backlights 48₁, 48₂, 48₃, and 48₄ and produces, by using commercial power, driving pulse voltages “e1”, “e2”, “e3”, and “e4” each having almost the same resonant frequency as that of the resonant circuit in synchronization with the timing signals “d1”, “d2”, “d3”, and “d4” and applies them to the backlights 48₁, 48₂, 48₃, and 48₄. A frequency of each of the driving pulse voltages “e1”, “e2”, “e3”, and “e4” is set according to set frequencies “f1”, “f2”, “f3”, and “f4” and a voltage of each of the driving pulse voltages “e1”, “e2”, “e3”, and “e4” is set according to a set voltage “v”.

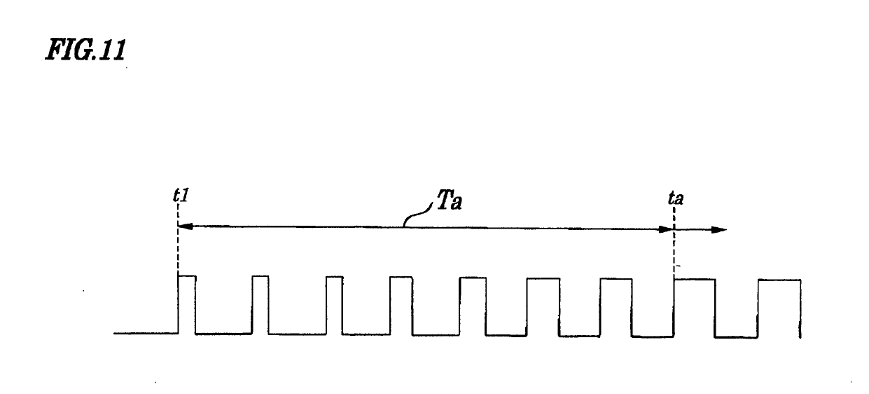

The backlights 48₁, 48₂, 48₃, and 48₄ are arranged on a rear of the liquid crystal panel 41 and are divided in a scanning direction (y direction) of the liquid crystal panel 41. Each of the backlights 48₁, 48₂, 48₃, and 48₄ light up by application of each of the driving pulse voltages “e1”, “e2”, “e3”, and “e4” and illuminate the liquid crystal panel 41. A frequency and a pulse width of each of the driving pulse voltages “e1”, “e2”, “e3”, and “e4” are set according to each of set frequencies “f1”, “f2”, “f3”, and “f4” and each of the driving pulse voltages “e1”, “e2”, “e3”, and “e4” is set according to the set voltage “v”. The frequency and pulse width of each of the driving pulse voltages “e1”, “e2”, “e3,”, and “e4” is set, if an amount of light is made constant, so that the frequency is inversely proportional to the pulse width. Each of the backlights 48₁, 48₂, 48₃, and 48₄ is constructed by using the same conventional configurations as shown in FIG. 11 and has a cold cathode fluorescent tube (not shown), a reflecting section (not shown), and a diffusing section (not shown). The cold cathode fluorescent tube lights up when each of the driving pulse voltages “e1”, “e2”, “e3”, and “e4” is applied. The reflecting section is made up of a film overlain with silver by using a sputtering method and reflects light emitted from the cold cathode fluorescent tube to illuminate the liquid crystal panel 41, and increases floating capacitance after the cold cathode fluorescent tube is powered off or powered down rather than before it is lit by making electrostatic capacitance be produced between the reflecting section and a plasma occurring in an inner portion of the cold cathode fluorescent tube. The diffusing section diffuses light reflected from the reflecting section and light emitted from the cold cathode fluorescent tube and illuminates the liquid crystal panel 41 uniformly.

The frequency setting sections 47₁, 47₂, 47₃, and 47₄ are made up of two or more logic circuits (not shown) and do setting of each of the set frequencies “f1”, “f2”, “f3”, and “f4” of each of the driving pulse voltages “e1”, “e2”, “e3”, and “e4” in a manner in which the frequencies “f1”, “f2”, “f3”, and “f4” can be changed according to a decrease in a resonant frequency caused by an increase in the floating capacitance occurring when a transition occurs from an initial state of lighting of the backlights 48₁, 48₂, 48₃, and 48₄ to their stabilized states. In the embodiment in particular, the frequency setting sections 47₁, 47₂, 47₃, and 47₄ set each of the set frequencies “f1”, “f2”, “f3”, and “f4” of each of the driving pulse voltages “e1”, “e2”, “e3”, and “e4” to be a frequency being near to a resonant frequency corresponding to the floating capacitance occurring in an initial period of lighting of the cold cathode tube in the backlights 48₁, 48₂, 48₃, and 48₄ and thereafter to be a frequency being near to a resonant frequency corresponding to floating capacitance occurring in a stabilized period of lighting of the cold cathode tube in the backlights 48₁, 48₂, 48₃, and 48₄. These frequencies “f1”, “f2”, “f3”, and “f4” and the time of changes are set, in advance, according to results of experiments and are stored in, for example, an LUT (Look Up Table) or a like.

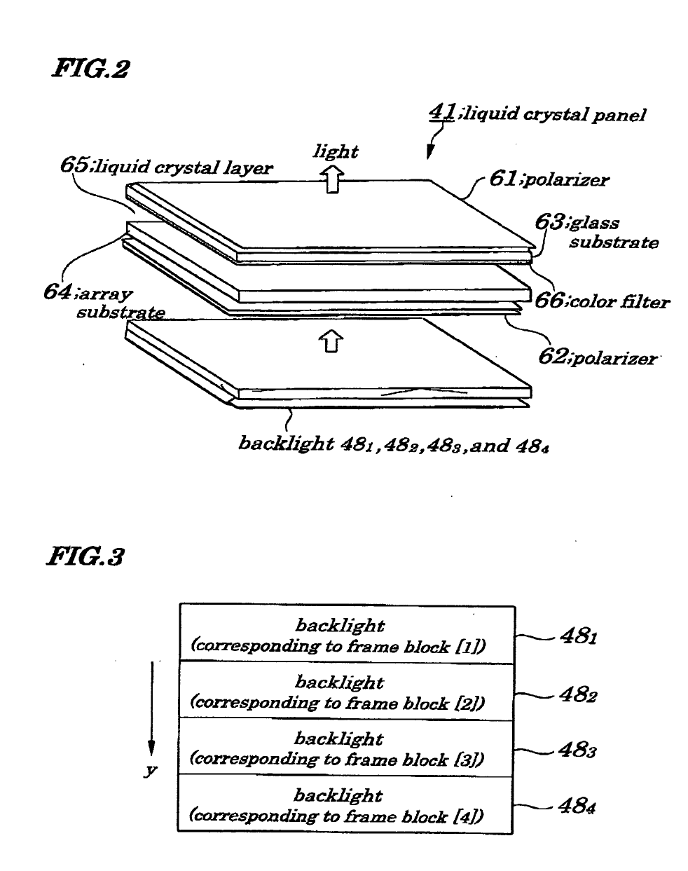

FIG. 2 is a diagram illustrating schematic configurations of the liquid crystal panel 41 and backlights 48₁, 48₂, 48₃, and 48₄ of the first embodiment of the present invention. The liquid crystal panel 41, as shown in FIG. 2, is made up of a pair of polarizers 61 and 62, a glass substrate 63, an array substrate 64, a liquid crystal layer 65 being interposed between the glass substrate 63 and the array substrate 64. On the glass substrate 63 is formed a color filter 66 for red (R), green (G), and blue (B) colors and one dot (a unit dot) is made up of three pixels (segments), one pixel (segment) emitting the R color, another pixel (segment) emitting the G color, and still another pixel (segment) emitting the B color. The array substrate 64 is a glass substrate on which active elements such as the TFTs 51_{i,j} or a like are mounted. Each of the backlights 48₁, 48₂, 48₃, and 48₄ is placed on a rear of the liquid crystal panel 41 and, as shown in FIG. 3, has almost the same size as a display screen of the liquid crystal panel 41 and is divided in a scanning direction (y direction) of the liquid crystal panel 41.

In the liquid crystal panel 41, white light emitted from the backlights 48₁, 48₂, 48₃, and 48₄ after having passed through the polarizer 62, becomes linearly polarized light and enters the liquid crystal layer 65. The liquid crystal layer 65 has a role of changing a shape of polarized light (angle and direction of polarization), however, this role is limited by the orientation of a liquid crystal and, therefore, the shape of the polarized light is controlled by a voltage corresponding to the pixel data Dᵢ. Depending on a shape of polarized light emitted from the liquid crystal layer 65, whether or not light emitted from the liquid crystal layer 65 is absorbed by the polarizer 61 is determined. Thus, transmittance of light is controlled by a voltage corresponding to the pixel data Dᵢ. Moreover, a color image is realized by an additive color mixture of light having passed through each of the R, G, and B color pixels in the color filter 66.

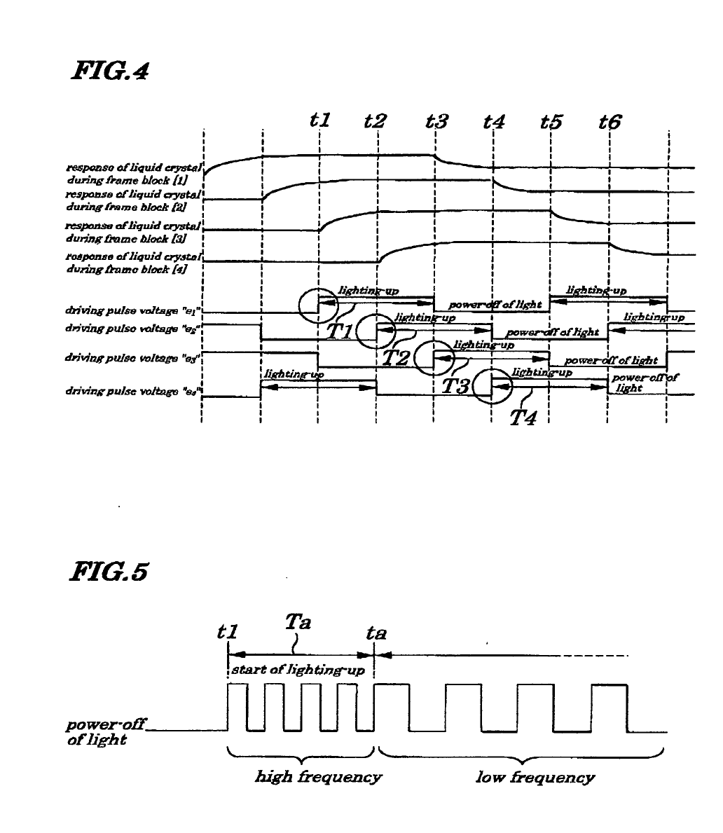

FIG. 4 is a timing chart explaining operations of the liquid crystal display device shown in FIG. 1 in which a state of a response of each of the liquid cells 52_{i,j} to the pixel data Dᵢ during each of the frame blocks [3], [2], [3], and [4] and a state of rising and falling of each of the driving pulse voltages “e1”, “e2”, “e3”, and “e4” is plotted as ordinate and time is plotted as abscissa FIG. 5 is a diagram illustrating a waveform of a voltage to be applied to each transformer mounted in the inverters 46₁, 46₂, 46₃, and 46₄ which occurs at time of rising of each of the driving pulse voltages “e1”, “e2”, “e3”, and “e4” shown in FIG. 4. A method of driving the liquid crystal display device of the first embodiment is described by referring to FIGS. 1 to 5. The video input signal VD is input to the controlling section 44 from which the control signal “a” is transmitted to the data electrode driving circuit 42 and the control signal “b” is transmitted to the scanning electrode driving circuit 43. Also, the vertical sync signal “c” is transmitted from the controlling section 44 to the lighting timing controlling section 45. Moreover, the video input signal VD is also input to the data electrode driving circuit 42 from which a voltage corresponding to the pixel data Dᵢ is applied to each of the data electrodes Xᵢ in the liquid crystal panel 41. The scanning signal OUTⱼ is applied from the scanning electrode driving circuit 43 to each of the scanning electrodes Yⱼ in the liquid crystal panel 41 in a one-pass scanning manner.

The light timing controlling section 45 divides, according to a vertical Sync signal “c”, one frame period for the video input signal VD into the frame blocks [1], [2], [3], and [4] each corresponding to a length of each of the backlights 48₁, 48₂, 48₃, and 48₄ in the scanning direction and generates each of the timing signals “d1”, “d2”, “d3”, and “d4” to make each of the backlights 48₁, 48₂, 48₃, and 48₄ flash on and off in a manner to correspond to each of the liquid crystal cells 52ᵢ,ⱼ in the liquid crystal panel 41 in each of the frame blocks [1], [2], [3], and [4] and each of the timing signals “d1”, “d2”, “d3”, and “d4” is transmitted to each of the inverters 46₁, 46₂, 46₃, and 46₄ and to each of the frequency setting sections 47₁, 47₂, 47₃, and 47₄.

The frequency setting sections 47₁, 47₂, 47₃, and 47₄ set, when the timing signals “d1”, “d2”, “d3”, and “d4” are input, each of the set frequencies “f1”, “f2”, “f3”, and “f4” of each of the driving pulse voltages “e1”, “e2”, “e3”, and “e4” to be a frequency being near to a resonant frequency corresponding to floating capacitance occurring at the time of start of lighting of the backlights 48₁, 48₂, 48₃, and 48₄ and, thereafter, to be a frequency being near to a resonant frequency corresponding to floating capacitance occurring after lighting in the backlights 48₁, 48₂, 48₃, and 48₄ (process of setting a frequency). In the inverters 46₁, 46₂, 46₃, and 46₄ the set frequencies “f1”, “f2”, “f3”, and “f4” and the driving pulse voltages “e1”, “e2”, “e3”, and “e4” set according to the set voltage “v” are generated. The driving pulse voltages “e1”, “e2”, “e3”, and “e4” are applied respectively to the backlights 48₁, 48₂, 48₃, and 48₄ which then light up to illuminate the liquid crystal panel 41.

For example, as shown in FIG. 4, at time “t1”, when a response of each of the liquid crystal cells 52ᵢ,ⱼ to the pixel data Dᵢ corresponding to the frame block [1] is complete, the driving pulse voltage “e1” is applied to the backlight 48₁ to turn ON the backlight 48₁. In this case, a pulse having such a waveform as shown in FIG. 5 is input to the transformer (not shown) of the inverter 46₁ and the frequency f₁ of the driving pulse voltage “e1” becomes as high as a frequency being near to a resonant frequency corresponding to the floating capacitance occurring in the initial period of lighting of the backlight 48₁ during a specified period “Ta” from the time “t1” to the time “ta” and then becomes as low as a frequency being near to a resonant frequency corresponding to the floating capacitance occurring in the stabilized period of the backlight 48₁ at the time “ta” onward. During the specified period “Ta”, several pulses having the driving pulse voltage “e1” are applied. At time “t3” (after a ½ frame period since the time “t1”), when a response of each of the liquid crystal cells 52_{i,j} in a subsequent frame starts, the driving pulse voltage “e1” is not applied to the backlight 48₁ which then is powered off or powered down and goes out.

At the time “t2”, when a response of each of the liquid crystal cells 52ᵢ,ⱼ to the pixel data D₁ corresponding to the frame block [2] is complete, the driving pulse voltage “e2” is applied to the backlight 48₂ which then lights up. The driving pulse voltage “e2” changes in the same way as in the case of the driving pulse voltage “e1”. At time t4, when a response of each of the liquid crystal cells 52_{i,j} in a subsequent frame start, no driving pulse voltage “e2” is applied to the backlight 48₂, which then is powered off or powered down and goes out. At the time “t3”, a response of each of the liquid crystal cells 52_{i,j} to the pixel data Dᵢ corresponding to the frame block [3] is complete, the driving pulse voltage “e3” is applied to the backlight 48₂ which then lights up. The frequency “f₃” of the driving pulse voltage “e3” changes in the same way as in the case of the driving pulse voltage “e1”. At time “t5”, when a response of each liquid crystal cells 52_{i,j} in a subsequent frame starts, no driving pulse voltage “e3” is applied to the backlight 48₃, which then is powered off or powered down and goes out.

At time “t4”, a response of each of the liquid crystal cells 52_{i,j} to the pixel data D₁ corresponding to the frame block [4] is complete, the driving pulse voltage “e4” is applied to the backlight 48₄ which then lights up. The set frequency f₄ of the driving pulse voltage “e4” changes in the same way as in the case of the driving pulse voltage “e1”. At time “t6”, when a response of each of the liquid crystal cells 52_{i,j} in a subsequent frame starts, no driving pulse voltage “e4” is applied to the backlight 48₄, which then is powered off or powered down and goes out.

Thus, according to the liquid crystal display device of the first embodiment of the present invention, when the timing signals “d1”, “d2”, “d3”, and “d4” are input to the frequency setting sections 47₁, 47₂, 47₃, and 47₄, since each of the set frequencies “f1”, “f2”, “f3”, and “f4” of each of the driving pulse voltages “e1”, “e2”, “e3”, and “e4” becomes as high as a frequency being near to a resonant frequency corresponding to floating capacitance occurring in the initial period of lighting of the backlights 48₁, 48₂, 48₃, and 48₄ and then becomes as low as a frequency being near to a resonant frequency occurring after lighting of the backlights 46₁, 48₂, 48₃, and 48₄, the backlights 48₁, 48₂, 48₃, and 48₄ light up even if lighting duration of the cold cathode fluorescent tube is long and a power factor can be improved and efficiency of feeding light to the liquid crystal panel 41 can be enhanced.

### Second Embodiment

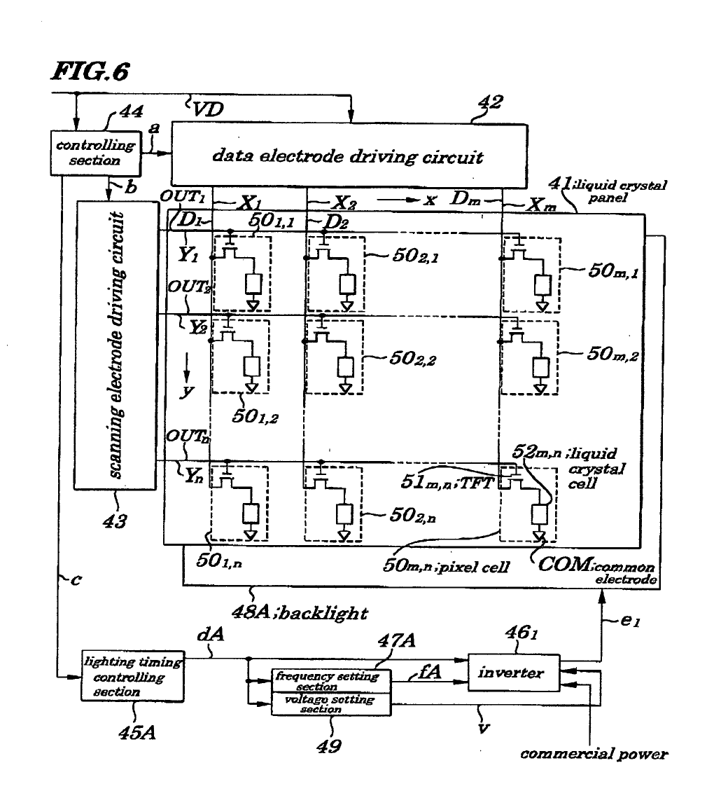

FIG. 6 is a schematic block diagram showing electrical configurations of a liquid crystal display device according to a second embodiment of the present invention. In FIG. 6, same reference numbers are assigned to components corresponding to those employed in the first embodiment shown in FIG. 1. The liquid crystal display device of the second embodiment includes a light timing controlling section 45A and frequency setting section 47A instead of the lighting timing controlling section 45 and frequency setting sections 47₁, 47₂, 47₃, and 47₄ shown in FIG. 1, wherein functions of the light timing controlling section 45A and the frequency setting section 47A are different from those of the lighting timing controlling section 45 and the frequency setting sections 47₁, 47₂, 47₃, and 47₄ shown in FIG. 1, and additionally includes a voltage setting section 49. The inverters 46₂, 46₃, and 46₄ (inverter 46₁ is retained) are not mounted and, instead of the backlights 48₁, 48₂, 48₃, and 48₄ shown in FIG. 1 and, unlike in the case of the first embodiment, a backlight 48A being not divided is attached. The lighting timing controlling section 45A generates a timing signal “dA” to make the backlight 48A flash on and off according to a vertical sync signal “c” in a manner to correspond to a response characteristic of the liquid crystal panel 41 during one frame period for a video input signal VD.

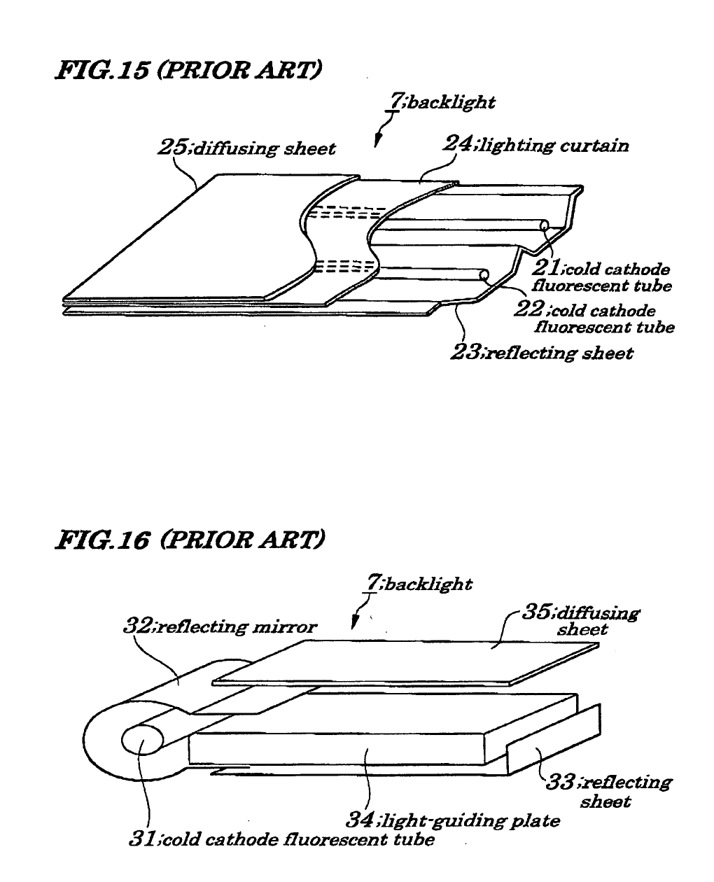

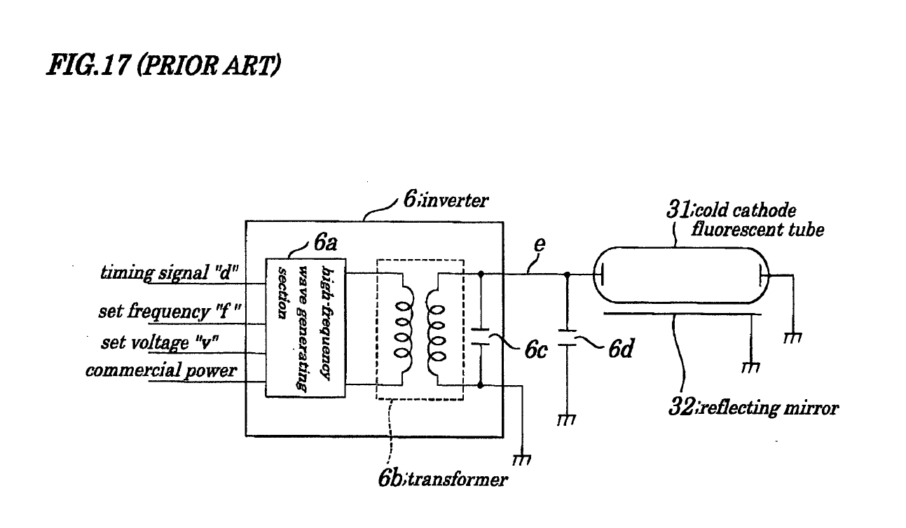

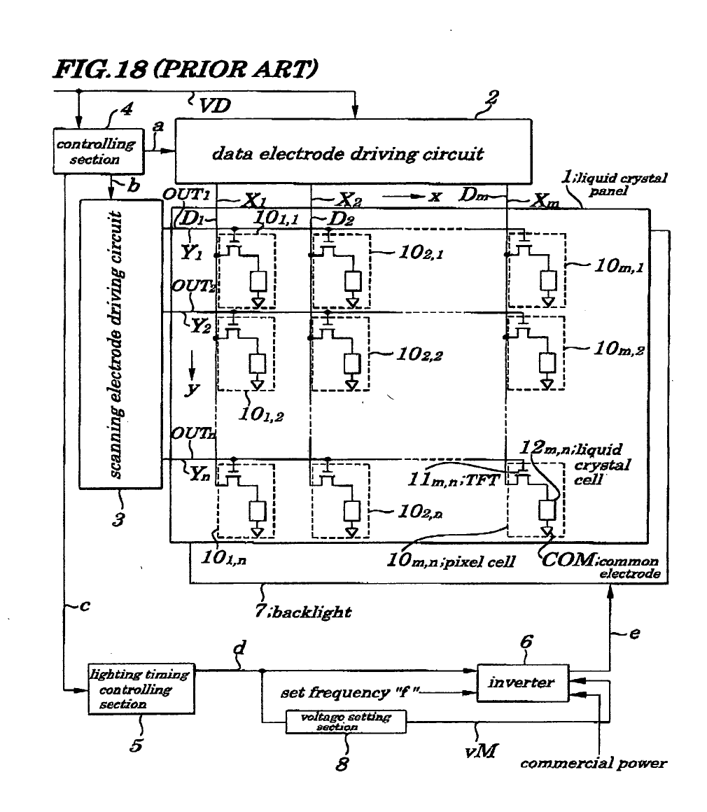

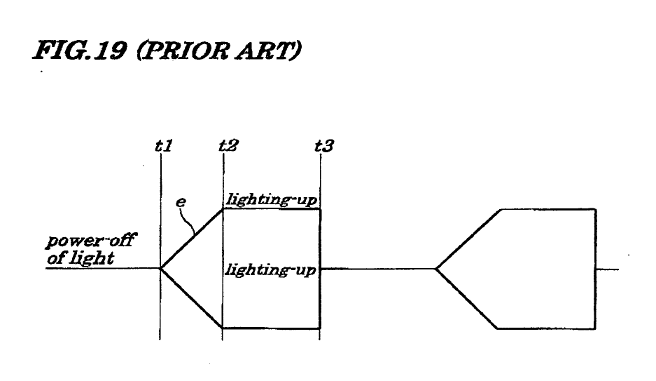

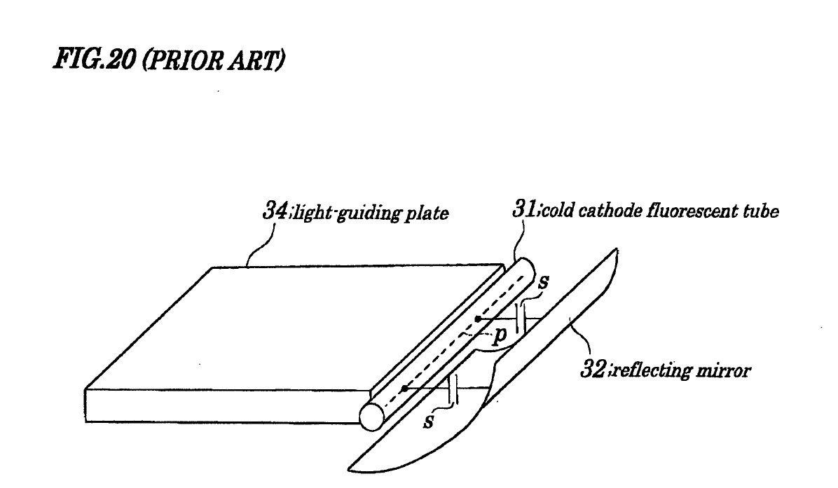

The voltage setting section 49 does setting of a set voltage “v” for the inverter 46₁ during a period from start time of lighting of the backlight 48A to a specified time so as to be gradually increased from an initial value to a set value. The backlight 48A is constructed so as to have the same configurations as the backlight 7 shown in FIG. 15 and has a cold cathode fluorescent tube (not shown), a reflecting section (not shown), and a diffusing section (not shown). The frequency setting section 47A sets a frequency “fA” of a driving pulse voltage “e1” so as to be changeable according to a decrease in a resonant frequency caused by an increase in floating capacitance occurring after a lapse of the period from start time of lighting of the cold cathode fluorescent tube in the backlight 48A to the specified time.

In the second embodiment in particular, the frequency setting sections 47A sets the frequency “fA” of the driving pulse voltages “e1” to be a frequency being near to a resonant frequency corresponding to floating capacitance occurring at the start time of lighting of the cold cathode tube and, after a lapse of the specified period of time, to be a frequency being near to a resonant frequency corresponding to floating capacitance occurring after lighting of the cold cathode fluorescent tube. Other configurations are the same as those employed in the first embodiment shown in FIG. 1.

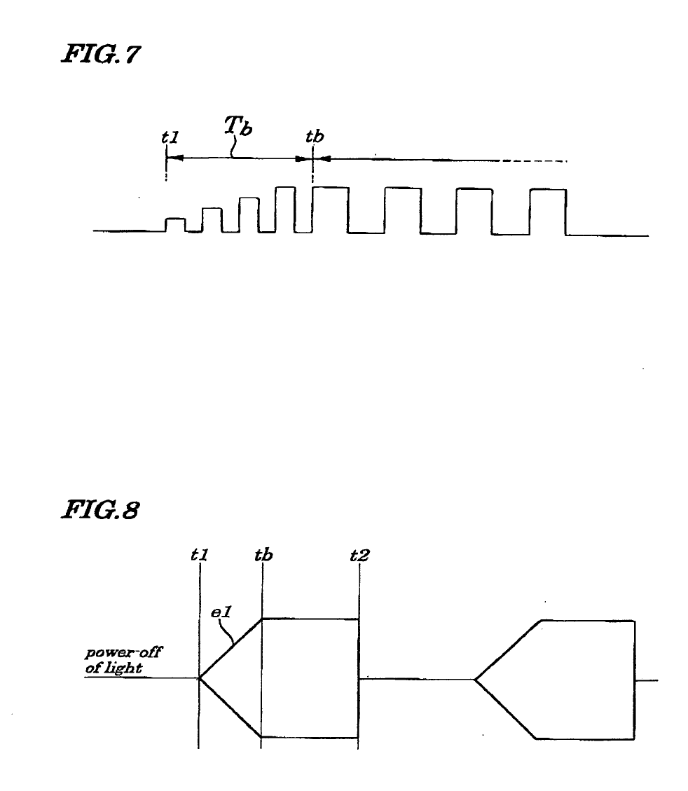

FIG. 7 is a diagram showing a waveform (not shown) of a pulse being input to the transformer of the inverter 46₁ when the driving pulse voltage “e1” shown in FIG. 6 is boosted according to the second embodiment. FIG. 8 is a timing chart explaining operations of the liquid crystal display device of the second embodiment. A method for driving the liquid crystal display device is described by referring to FIGS. 6 to 8. In the liquid crystal display device, in order to suppress mechanical vibration of each component in the inverter 46₁ and backlight 48A, the voltage setting section 49 does setting of the driving pulse voltage “e1” so as to gradually increase from its initial value to a specified value during a period from start time of lighting of the backlight 48A to specified time. Also, the frequency setting sections 47A sets the frequency “fA” of the driving pulse voltage “e1” so as to be changeable according to a decrease in a resonant frequency caused by an increase in floating capacitance occurring after a lapse of the period from start time of lighting of the backlight 48A to specified time (process of setting a frequency).

In this case, a voltage having a waveform as shown in FIG. 7 is input to the transformer (not shown) of the inverter 46 and the frequency “fA” of the driving pulse voltage “e1” becomes as high as a frequency being near to a resonant frequency corresponding to floating capacitance occurring at start time of lighting of the backlight 48A during a specified period “Tb” from a time “t1” to a time “tb” and gradually increases from its initial value to a set value and, at the time “tb” onward, becomes as low as a frequency being near to a resonant frequency corresponding to floating capacitance occurring in the stabilized period of lighting of the backlight 48A and reaches the specified level and, thereafter, same operations are repeated.

As described above, in the second embodiment, since the frequency “fA” of the driving pulse voltage “e1” becomes as high as a frequency being near to a resonant frequency corresponding to floating capacitance occurring at start time of lighting of the backlight 48A during the specified period “Tb” from the time “t1” to the time “tb”, even if the driving pulse voltage “e1” is lower than the specified value, the frequency “fA” is set properly and the backlight 48A lights up smoothly to illuminate the liquid crystal panel 41.

### Third Embodiment

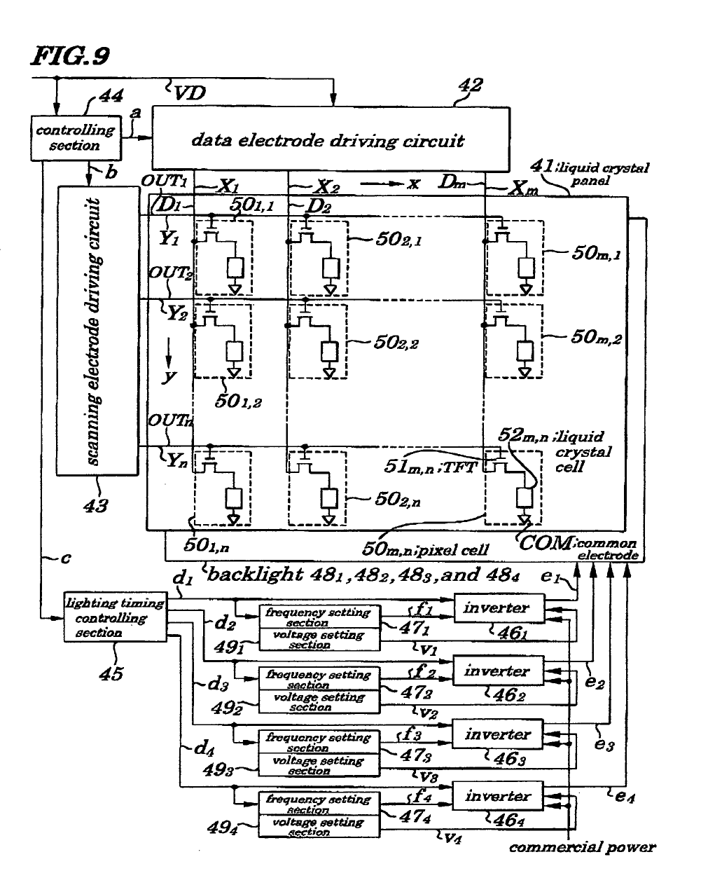

FIG. 9 is a schematic block diagram showing electrical configurations of a liquid crystal display device according to a third embodiment of the present invention. In FIG. 9, same reference numbers are assigned to components corresponding to those in the first and second embodiments shown in FIGS. 1 and 6. The liquid crystal display device of the third embodiment, as shown in FIG. 9, includes, in addition to components used in the liquid crystal display device shown in FIG. 1, voltage setting sections 49₁, 49₂, 49₃, and 49₄ each having the same function as the voltage setting section 49 shown in FIG. 6. The voltage setting sections 49₁, 49₂, 49₃, and 49₄ do setting of voltages v1, v2, v3, and v4 to be applied to inverters 46₁, 46₂, 46₃, and 46₄ so that each of driving pulse voltages “e1”, “e2”, “e3”, and “e4” gradually increases from its initial value to a set value during a period from start time of lighting of each of backlights 48₁, 48₂, 48₃, and 48₄ to a specified time. Other configurations are the same as those shown in FIG. 1.

In the liquid crystal display device of the third embodiment, in order to prevent mechanical vibration of each components mounted in the inverters 46₁, 46₂, 46₃, and 46₄ and in the backlights 48₁, 48₂, 48₃, and 48₄, as in the case of the second embodiment, each of the voltage setting sections 49₁, 49₂, 49₃, and 49₄ does setting of each of the driving pulse voltages “e1”, “e2”, “e3”, and “e4” so as to gradually increase from its initial value to a specified value during a period from start time of lighting of the backlights 48₁, 48₂, 48₃, and 48₄ to the specified time. Moreover, frequency setting sections 47₁, 47₂, 47₃, and 47₄ change frequencies f₁, f₂, f₃, and f₄ of the driving pulse voltages “e1”, “e2”, “e3”, and “e4” according to a decrease in a resonant frequency caused by an increase in floating capacitance occurring after a lapse of the period from start time of lighting of each of the backlights 48₁, 48₂, 48₃, and 48₄ to the specified time (process of setting frequency).

Thus, according to the liquid crystal display device of the third embodiment, since the voltage setting sections 49₁, 49₂, 49₃, and 49₄ do setting of each of the driving pulse voltages “e1”, “e2”, “e3”, and “e4” so as to gradually increase from its initial value to a specified value during a period from start time of lighting of the backlights 48₁, 48₂, 48₃, and 48₄ to the specified time, there is an advantage in that the backlights 48₁, 48₂, 48₃, and 48₄ light up smoothly to illuminate the liquid crystal panel 41, in addition to the advantages achieved in the first embodiment.

### Fourth Embodiment

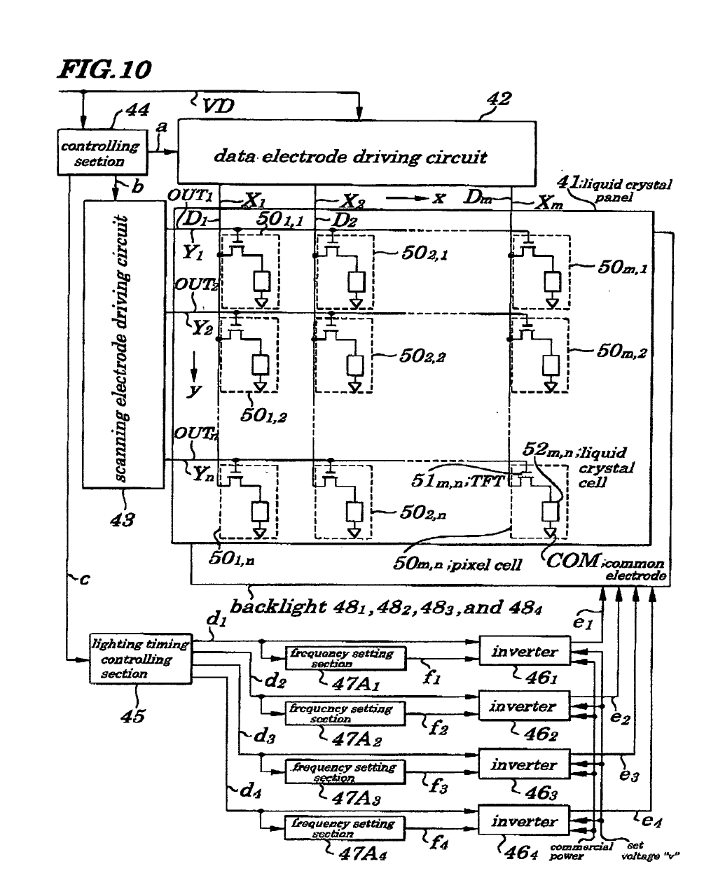

FIG. 10 is a schematic block diagram showing electrical configurations of a liquid crystal display device according to a fourth embodiment of the present invention. In FIG. 10, same reference numbers are assigned to components corresponding to those employed in the first embodiment shown in FIG. 1. The liquid crystal display device of the fourth embodiment, as shown in FIG. 10, has frequency setting sections 47A₁, 47A₂, 47A₃, and 47A₄ having new functions, instead of the frequency setting sections 47₁, 47₂, 47₃, and 47₄ shown in FIG. 1. Each of the frequency setting sections 47A₁, 47A₂, 47A₃, and 47A₄ has a function of gradually increasing each of the driving pulse voltages “e1”, “e2”, “e3”, and “e4” to be applied to each of inverters 46₁, 46₂, 46₃, and 46₄, when a transition occurs from an initial state of lighting of the backlights 48₁, 48₂, 48₃, and 48₄ to a stabilized state, from its initial value to a value corresponding to a specified amount of light emitted from the backlights 48₁, 48₂, 48₃, and 48₄, in addition to the functions that the frequency setting sections 47₁, 47₂, 47₃, and 47₄ have. Other configurations are the same as those in FIG. 1.

A method for driving the liquid crystal display device of the fourth embodiment differs from that employed in the first embodiment in following points. That is, at a time “t1”, a voltage hating a waveform shown in FIG. 11 is input to a transformer (not shown) of the inverter 46₁. A frequency of the voltage having the above waveform becomes large during a period “Ta” from time “t1” to time “ta” and a pulse width gradually increases. Due to this, the driving pulse voltage “e1” gradually increases from its initial value to a value corresponding to a specified amount of light from the backlight 48₁, 48₂, 48₃, and 48₄ during a period “Ta” from the time “t1” to the time “ta” (process of setting a frequency). In this case, the state of an increase in the driving pulse voltage “e1” is almost the same as the increase occurring during a period from the time “t1” to the time “tb” in the second embodiment in FIG. 8. Operations to be performed at the time “ta” onward are the same as in the first embodiment. Moreover, each of the driving pulse voltages “e1”, “e2”, “e3”, and “e4”, when a transition occurs from an initial state of lighting of the backlights 48₁, 48₂, 48₃, and 48₄ to their stabilized state, changes in the same way as in the case of the driving pulse voltage “e1”.

Thus, according to the liquid crystal display device of the fourth embodiment, since each of the driving pulse voltages “e1”, “e2”, “e3”, and “e4” gradually increases from its initial value to a value corresponding to a specified amount of light from the backlights 48₁, 48₂, 48₃, and 48₄ when a transition occurs from an initial state of lighting of the backlights 48₁, 48₂, 48₃and 48₄ to a stabilized state, mounting of such the voltage setting sections 49₁, 49₂, 49₃, and 49₄ as employed in the third embodiment shown in FIG. 9 is not needed, which enables the liquid crystal display device of the fourth embodiment to be constructed by using a comparatively simple configuration and the backlights 48₁, 48₂, 48₃, and 48₄ can light up smoothly to illuminate the liquid crystal panel as in the case of the third embodiment.

### Fifth Embodiment

The liquid crystal display device shown in FIG. 10 has still a problem in that, when the backlights 48₁, 48₂, 48₃, and 48₄ is powered off or powered down, each of the components making up the inverters 46₁, 46₂, 46₃, and 46₄ and each of the components making up the backlights 48₁, 48₂, 48₃, and 48₄ mechanically vibrate which causes a vibration sound (noise) to occur. However, according to the liquid crystal display device of the fifth embodiment, the above problem is solved by gradually decreasing each of the driving pulse voltages “e1”, “e2”, “e3”, and “e4” when the backlights 48₁, 48₂, 48₃, and 48₄ are powered off or powered down.

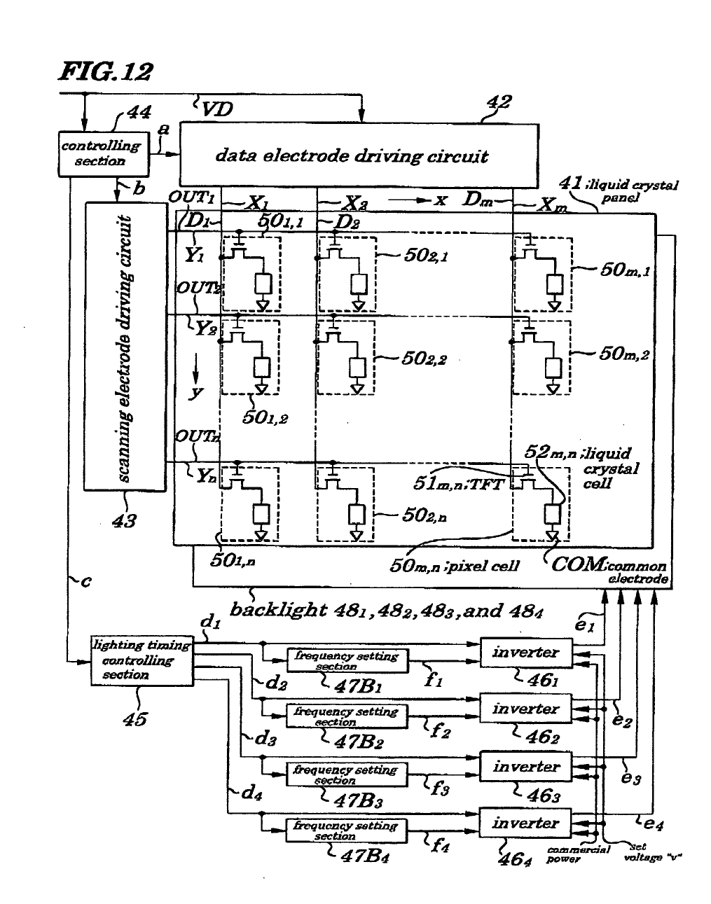

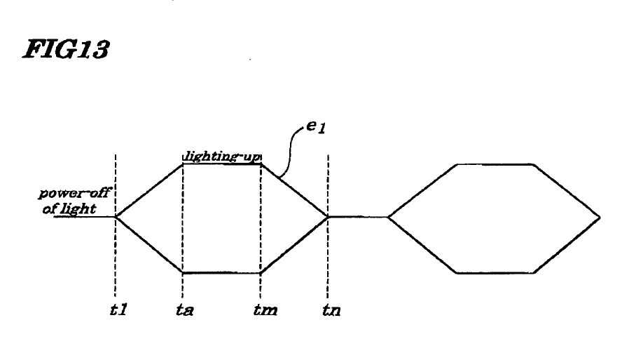

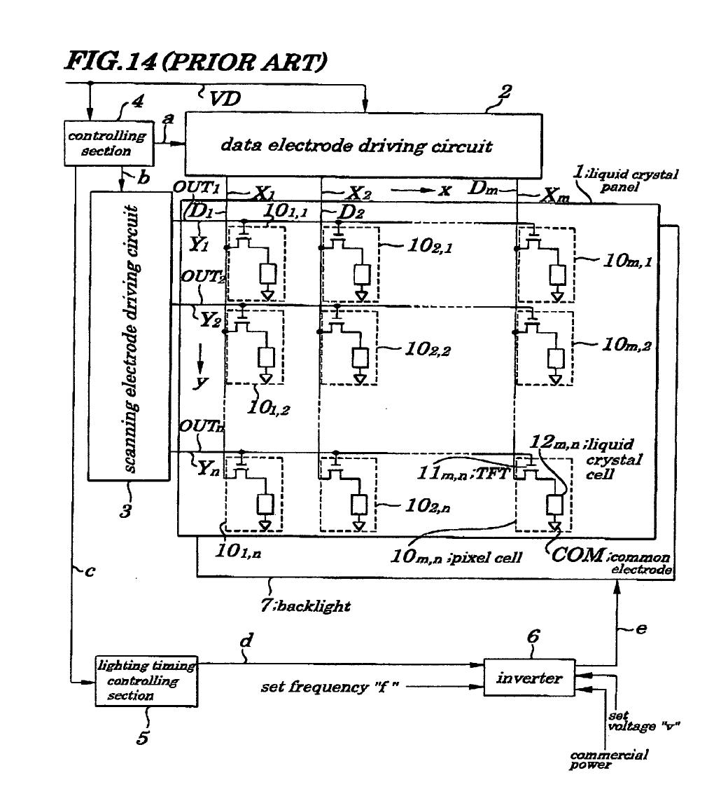

FIG. 12 is a schematic block diagram showing electrical configurations of a liquid crystal display device according to a fifth embodiment of the present invention. In FIG. 12, same reference numbers are assigned to components corresponding to those in the fourth embodiment shown in FIG. 10. The liquid crystal display device of the fifth embodiment, as shown in FIG. 12, newly includes, instead of the frequency setting sections 47A₁, 47A₂, 47A₃, and 47A₄ shown in FIG. 10, frequency setting sections 47B₁, 47B₂, 47B₃, and 47B₄ each having a new function. Each of the frequency setting sections 47B₁, 47B₂, 47B₃, and 47B₄ has a function of gradually decreasing each of the driving pulse voltages “e1”, “e2”, “e3”, and “e4”, when a transition occurs from a stabilized state of lighting of the backlights 48₁, 48₂, 48₃, and 48₄ to a power-off or power-down state, from a value corresponding to a specified amount of light from backlights 48₁, 48₂, 48₃, and 48₄ from an initial values in addition to the different functions that the frequency setting sections 47A₁, 47A₂, 47A₃, and 47A₄ shown in FIG. 10 have. Other configurations are the same as those shown in FIG. 10.

The liquid crystal display device of the fifth embodiment differs from that of the fourth embodiment in following points. That is, when a transition occurs from a stabilized state of lighting of the backlight 48₄ to its power-off or power-down state, a voltage having a waveform obtained by reversing the waveform occurring during a period from time “tm” to time “tn” in the fourth embodiment in FIG. 11 toward a time-axis direction is applied to the inverter 46₁ and, as shown in FIG. 13, during a period from the time “tm” to the time “tn”, the driving pulse voltage “e1” gradually decreases from a value corresponding to a specified amount of light from the backlight 48₁ to its initial value (process of setting a frequency). Moreover, each of the driving pulse voltages “e2”, “e3”, and “e4”, when a transition occurs from the stabilized state of lighting of the backlights 48₂, 48₃, and 48₄, changes in the same way as in the case of the driving pulse voltage “e1”.

Thus, in the fifth embodiment, when the backlights 48₁, 48₂, 48₃, and 48₄ are powered off or powered down, each of the driving pulse voltages “e1”, “e2”, “e3”, and “e4” is made to gradually decrease and, therefore, occurrence of a vibration sound being produced when the backlights 48₁, 48₂, 48₃, and 48₄ are powered off or powered down can be prevented.

It is apparent that the present invention is not limited to the above embodiments but may be changed and modified without departing from the scope and spirit of the invention. For example, in the first embodiment shown in FIG. 4, setting is done so that the backlights 48₁, 48₂, 48₃, and 48₄ light up during a ½ frame period, however, if a response of the liquid crystal cell 52_{i,j} is complete, any length can be used. Also, in the first embodiment, the backlights 48₁, 48₂, 48₃, and 48₄ are divided and one frame period for a video input signal VD is divided into the frame blocks [1], [2], [3], and [4], however, even if such the divided configurations are not employed, almost the same effect as obtained in the first embodiment can be realized. Also, in the second embodiment shown in FIG. 8, the driving pulse voltage “e1” linearly increases from the time “t1” to the time “tb”, however, it may be increased exponentially by using, for example, a time-constant circuit.

Also, in each of the above embodiments, the liquid crystal panel 41 of a transmission type is employed, however, the present invention is not limited to this type and the liquid crystal panel 41 of a reflection type may be used. That is, instead of the backlights 48₁, 48₂, 48₃, and 48₄ shown in FIG. 1 or FIG. 9, by placing four light-guiding units being divided in a scanning direction on a display side of the liquid crystal panel 41 and by attaching a light source such as a cold cathode fluorescent tube on a side of light incident face on each of the light-guiding units and by attaching a reflecting plate on a rear side of the liquid crystal panel 41, almost the same effect as obtained in the first and third embodiments can be realized. Similarly, instead of the backlight 48A shown in FIG. 6, by placing light-guiding units on a display side of a liquid crystal panel 41 and by attaching a light source such as a cold cathode fluorescent tube on a side of light incident face on each of the light-guiding units and also a reflecting plate on a rear side of the liquid crystal panel, almost the same effect as obtained in the second embodiment can be realized. Also, the frequency and a pulse width of the driving pulse voltages “e1”, “e2”, “e3”, and “e4” can be set according to set each of frequencies f₁, f₂, f₃, and f₄ of each of the driving pulse voltages “e1”, “e2”, “e3”, and “e4”, however, the pulse width may be set from outside depending on a necessary amount of light. Moreover, in the fourth and fifth embodiments, the backlights 48₁, 48₂, 48₃, and 48₄ are divided, however, even if they are not divided, almost the same action and effect as obtained in the fourth and fifth embodiments can be realized.

1. A liquid crystal display device comprising;
a liquid crystal panel;
at least one surface light source to uniformly illuminate said liquid crystal panel: and
at least one surface light source driving section to apply a driving pulse voltage to said surface-light source; and
wherein, at least one frequency setting section is added, which changes, when a transition occurs from an initial state of lighting of said surface light source to its stabilized state, a set value of a frequency of said driving pulse voltage.

2. The liquid crystal display device according to claim 1, wherein said surface light source driving section comprises: a resonant circuit configured so as to resonate in combination with a floating capacitance occurring in said surface light source and to apply said driving pulse voltage whose frequency is set to be a frequency being near to a resonant frequency of said resonant circuit to said surface light source; and wherein said frequency setting section is so configured as to change a set value of a frequency of said driving pulse voltage according to a decrease in said resonant frequency caused by an increase in said floating capacitance occurring when said transition occurs from said initial state of lighting of said surface light source to the stabilized state.

3. The liquid crystal display device according to claim 1, wherein said surface light source comprises:
a cold cathode fluorescent tube which lights up when said driving pulse voltage is applied to;
a reflecting section which reflects light emitted from said cold cathode fluorescent tube and which increases said floating capacitance more in the stabilized period of lighting of said cold cathode fluorescent tube rather than in the initial state by making an electrostatic capacitance be produced between said reflecting section and a plasma generated within said cold cathode fluorescent tube;
a diffusing section which diffuses light reflected from said reflecting section and light emitted from said cold cathode fluorescent tube to illuminate said liquid crystal panel uniformly; and
wherein said frequency setting section is so configured as to set a frequency of said driving pulse voltage to be a frequency being near to a resonant frequency corresponding to said floating capacitance occurring in the initial period of lighting of said cold cathode fluorescent tube and then to set said frequency to be a frequency being near to the resonant frequency corresponding to said floating capacitance occurring in said stabilized period of lighting of said cold cathode fluorescent tube.

4. A liquid crystal display device comprising:
a liquid crystal panel;
a surface light source to uniformly illuminate said liquid crystal panel;
a surface light source driving section to apply a driving pulse voltage to said surface light source;
a voltage setting section which sets said driving pulse voltage so as to gradually increase during a period from a start time of lighting of said surface light source to a specified time; and
wherein a frequency setting section is added which changes a set value of a frequency of said driving pulse voltage after a lapse of said period from said start time of lighting of said surface light source to the specified time.

5. The liquid crystal display device according to claim 4, wherein said surface light source driving section comprises: a resonant circuit that resonates in combination with a floating capacitance occurring in said surface light source and is so configured as to apply said driving pulse voltage whose frequency is set to be a frequency being near to a resonant frequency of said resonant circuit to said surface light source; and wherein said frequency setting section is so configured as to change a set value of a frequency of said driving pulse voltage according to a decrease in said resonant frequency caused by an increase in said floating capacitance occurring after the lapse of said period from said start time of lighting of said surface light source to the specified time.

6. The liquid crystal display device according to claim 4, wherein said surface light source comprises:
a cold cathode fluorescent tube which lights up when said driving pulse voltage is applied;
a reflecting section which reflects light emitted from said cold cathode fluorescent tube and increases said floating capacitance more after the lapse of said specified period rather than at the start time of lighting of said cold cathode fluorescent tube by making an electrostatic capacitor be produced between said reflecting section and a plasma generated within said cold cathode fluorescent tube;
a diffusing section which diffuses light reflected from said reflecting section and light emitted from said cold cathode fluorescent tube to illuminate said liquid crystal panel uniformly; and
wherein said frequency setting section is so configured as to set a frequency of said driving pulse voltage to be a frequency being near to a resonant frequency corresponding to said floating capacitance occurring at the time of lighting of said cold cathode fluorescent tube and, after the lapse of said specified period, to be a frequency being near to a resonant frequency corresponding to said floating capacitance occurring in the stabilized period of lighting of said cold cathode fluorescent tube.

7. A liquid crystal display device comprising:
a liquid crystal panel;
two or more surface light source blocks which are divided in a scanning direction of said liquid crystal panel and light up when a driving pulse voltage is applied to and are used to uniformly illuminate related regions in said liquid crystal panel;
a lighting timing controlling section which divides one frame period for a video input signal into two or more frame blocks each corresponding to a length in said scanning direction of each of said surface light source blocks and which generates two or more timing signals to make each of said surface light source blocks flash on and off in a manner to correspond to a response characteristic of said liquid crystal panel during each of said frame blocks; and
two or more surface light source block driving sections to apply each driving pulse voltage to each of said surface light source blocks in synchronization with each of said timing signals;
wherein two or more frequency setting sections are added to change a set value of a frequency of each said driving pulse voltages, when a transition occurs from an initial state of lighting of each of said surface light source blocks to its stabilized state.

8. The liquid crystal display device according to claim 7, wherein each of said surface light blocks has a resonant circuit which resonates in combination with a floating capacitance occurring in each of said surface light source blocks and wherein each of said surface light source blocks applies each said driving pulse voltages whose frequency is set to be a frequency being near to a resonant frequency of said resonant circuit to each of said surface light source blocks in synchronization with each of said timing signals; and wherein each of said frequency setting sections is so configured-as to change a set value of a frequency of each said driving pulse voltages according to a decrease in said resonant frequency caused by an increase in said floating capacitance occurring when a transition occurs from said initial state of lighting of each of said surface light source blocks to the stabilized state.

9. The liquid crystal display device of claim 7, wherein each of said surface light source blocks comprises:
a cold cathode fluorescent tube which lights up when each of said driving pulse voltages is applied to;
a reflecting section which reflects light emitted from said cold cathode fluorescent tube and which increases said floating capacitance more in a stabilized period of lighting of said cold cathode fluorescent tube rather than in the initial state by making an electrostatic capacitor be produced between said reflecting section and plasma generated within said cold cathode fluorescent tube;
a diffusing section which diffuses light reflected from said reflecting section and light emitted from said cold cathode fluorescent tube to illuminate said liquid crystal panel uniformly,
wherein said frequency setting section is so configured as to set a frequency of said driving pulse voltages to be a frequency being near to a resonant frequency corresponding to said floating capacitance occurring in an initial period of lighting of said cold cathode fluorescent tube and then the frequency to be a frequency being near to a resonant frequency corresponding to said floating capacitance occurring in the stabilized period of lighting of said cold cathode fluorescent tube.

10. A liquid crystal display device comprising:
a liquid crystal panel;
two or more surface light source blocks which are divided in a scanning direction of said liquid crystal panel and light up when a driving pulse voltage is applied to and uniformly illuminate related regions in said liquid crystal panel;
a lighting timing controlling section which divides one frame period for a video input signal into two or more frame blocks each corresponding to a length in said scanning direction of each of said surface light source blocks and which generates two or more timing signals to make each of said surface light source blocks flash on and off in a manner to correspond to a response characteristic of said liquid crystal panel during each of said frame blocks:
two or more surface light source block driving sections to apply each driving pulse voltage to said surface light source blocks in synchronization with said timing signals; And
two or more voltage setting sections to set said driving pulse voltage so as to gradually increase from an initial value to a set value during a period from a start time of lighting of each of said surface light source blocks to a specified time; and
wherein two or more frequency setting sections are added which change a frequency of each driving pulse voltage after a lapse of said period from the start time of lighting of each of said surface light source blocks to the specified time.

11. The liquid crystal display device according to claim 10, wherein each of said surface light source block driving sections includes a resonant circuit which resonates in combination with a floating capacitance occurring in said surface light source block and is so configured as to apply each said driving pulse voltage whose frequency is set to be near to a resonant frequency of said resonant circuit to said surface light source block in synchronization with each of said timing pulses, and wherein each of said frequency setting sections changes a set value of a frequency of each said driving pulse voltage according to a decrease in said resonant frequency caused by an increase in said floating capacitance occurring after a lapse of said period from the start time of lighting of each of said surface light source blocks to the specified time.

12. The liquid crystal display device according to claim 10, wherein each of said surface light source blocks comprises:
a cold cathode fluorescent tube which lights up when each of said driving pulse voltages is applied to;
a reflecting section which reflects light emitted from said cold cathode fluorescent tube and which increases said floating capacitance more in a stabilized period of lighting of said cold cathode fluorescent tube rather than in its initial period by making an electrostatic capacitance be produced between said reflecting section and a plasma generated within said cold cathode fluorescent tube;
a diffusing section which diffuses light reflected from said reflecting section and light emitted from said cold cathode fluorescent tube to illuminate said liquid crystal panel uniformly,
wherein said frequency setting section is so configured as to set a frequency of said driving pulse voltages to be a frequency being near to a resonant frequency corresponding to said floating capacitance occurring at the start time of lighting of said cold cathode fluorescent tube and, after a lapse of said specified period, the frequency to be a frequency being near to a resonant frequency corresponding to said floating capacitance occurring in a stabilized period of lighting of said cold cathode fluorescent tube.

13. The liquid crystal display device according to claim 1, wherein said frequency setting section is so configured as to gradually increase, when a transition occurs from said initial state of lighting of said surface light source to its stabilized state, each said driving pulse voltage from an initial value to a value corresponding to a specified amount of light emitted from said surface light source.

14. The liquid crystal display device according to claim 1, wherein said frequency setting section is so configured as to gradually decrease, when a transition occurs from the stabilized state of lighting of said surface light source to a state of power-off or power-down of lighting of said surface light source, each said driving pulse voltage from a value corresponding to a specified amount of light emitted from said surface light source to its initial value.

15. The liquid crystal display device according to claim 7, wherein each of said frequency setting sections is so configured as to gradually increase, when a transition occurs from the initial state of lighting of each of said surface light source blocks to the stabilized state, each said driving pulse voltage from the initial value to a value corresponding to a specified amount of light emitted from each of said surface light source blocks.

16. The liquid crystal display device according to claim 7, wherein each of said frequency setting sections is so configured as to gradually decrease, when a transition occurs from the stabilized state of lighting of each of said surface light source blocks to a state of power-off or power-down of each of said surface light source blocks, each said driving pulse voltage from a value corresponding to a specified amount of light emitted from each of said surface light source blocks to the initial value.

17. A driving method to-be used in a liquid crystal display device having a liquid crystal panel, at least one surface light source to uniformly illuminate said liquid crystal panel, and at least one surface light source driving section to apply a driving pulse voltage to said surface light source, for driving said surface light source, said method comprising:
a frequency setting step of changing, when a transition occurs from an initial state of lighting of said surface light source to its stabilized state, a set value of a frequency of said driving pulse voltage.

18. A driving method to be used in a liquid crystal display device having a liquid crystal panel, a surface light source to uniformly illuminate said liquid crystal panel, a surface light source driving section to apply a driving pulse voltage to said surface light source, and a voltage setting section which sets said driving pulse voltage so as to gradually increase during a period from a start time of lighting of said surface light source to a specified time, for driving said surface light source, said method comprising:
a frequency setting step of changing a set value of a frequency of said driving pulse voltage after a lapse of said period from the start time of lighting of said surface light source to the specified time.

19. A driving method to be used in a liquid crystal display device having a liquid crystal panel, two or more surface light source blocks which are divided in a scanning direction of said liquid crystal panel and light up when a driving pulse voltage is applied to and are used to uniformly illuminate related regions in said liquid crystal panel, a lighting timing controlling section which divides one frame period for a video input signal into two or more frame blocks each corresponding to a length in said scanning direction of each of said surface light source blocks and which generates two or more timing signals to make each of said surface light source blocks flash on and off in a manner to correspond to a response characteristic of said liquid crystal panel during every frame block, and two or more surface light source block driving sections to apply each driving pulse voltage to each of said surface light source blocks in synchronization with each of said timing signals, for driving said surface light source blocks, said method comprising:
a frequency setting step of changing a set value of a frequency of each said driving pulse voltage, when a transition occurs from an initial state of lighting of each of said surface light source blocks to its stabilized state.

20. A driving method to be used in a liquid crystal display device having a liquid crystal panel, two or more surface light source blocks which are divided in a scanning direction of said liquid crystal panel and light up when a driving pulse voltage is applied to and uniformly illuminate related regions in said liquid crystal panel, a lighting timing controlling section which divides one frame period for a video input signal into two or more frame blocks each corresponding to a length in said scanning direction of each of said surface light source blocks and which generates two or more timing signals to make each of said surface light source blocks flash on and off in a manner to correspond to a response characteristic of said liquid crystal panel during each of said frame blocks, two or more surface light source block driving sections to apply each said driving pulse voltages to said surface light source blocks in synchronization with said timing signals, and two or more voltage setting sections to set said driving pulse voltages so as to gradually increase from an initial value to a set value during said period from start time of lighting of each of said surface light source blocks to the specified time, for driving said surface light source blocks, said method comprising;
a frequency setting step of changing a set value of a frequency of each driving pulse voltage after a lapse of said period from start time of lighting of each of said surface light source blocks to specified time.

21. The driving method according to claim 17, wherein, in said frequency setting step, when a transition occurs from the initial state of lighting of said surface light source to the stabilized state, said driving pulse voltage is gradually increased from the initial value to a value corresponding to the specified amount of light emitted from said surface light source.

22. The driving method according to claim 17, wherein, in said frequency setting step, when a transition occurs from the stabilized state of lighting of said surface light source to a power-off or power-down state, said driving pulse voltage is gradually decreased from a value corresponding to the specified amount of light emitted from said surface light source to the initial value.

23. The driving method according to claim 19, wherein, in said frequency setting step, when a transition occurs from an initial state of lighting of each of said surface light source blocks to the stabilized state, said driving pulse voltage is gradually increased from an initial value to a value corresponding to the specified amount of light emitted from each of said surface light source blocks.

24. The driving method according to claim 19, wherein, in said frequency setting step, when a transition occurs from the stabilized state of lighting of each of said surface light source blocks to a power-off or power-down state, said driving pulse voltage is gradually decreased from a value corresponding to the specified amount of light emitted from each of said surface light source blocks to the initial value.
